(19) United States
(12) Patent Application Publication
(10) Pub. No.: US 2022/0114007 A1
(43) Pub. Date: Apr. 14, 2022

(54) DEVICE DRIVERS

(71) Applicant: KAL ATM Software GmbH, Munich (DE)

(72) Inventors: Aravinda Korala, Edinburgh (GB); Kit Patterson, Edinburgh (GB)

(73) Assignee: KAL ATM Software GmbH, Munich (DE)

(21) Appl. No.: 17/426,995

(22) PCT Filed: Jan. 30, 2020
(86) PCT No.: PCT/GB2020/050224

§ 371 Date: Jul. 29, 2021

(30) Foreign Application Priority Data
Jan. 30, 2019 (GB) 1901298.8

(51) Int. Cl. G06F 9/455; G06F 9/4401; G06F 9/445

(52) U.S. Cl. CPC G06F 9/45558; G06F 9/45545; G06F 2009/45579; G06F 9/4451; G06F 9/4411

(57) ABSTRACT

A user terminal apparatus comprises: a hypervisor or other virtual machine host, operable to provide a virtual machine; a guest operating system that is hosted within the virtual machine; a plurality of hardware devices; a plurality of device drivers associated with the plurality of devices; and at least one application or other software configured to run on the virtual machine to communicate with and/or control one or more of the devices via said guest operating system and via one or more of said device drivers, wherein said one or more device drivers comprise device drivers that are supported by the hypervisor or other virtual machine host; and at least some of said hardware devices supported by the hypervisor or other virtual machine host are unsupported by the guest operating system.

### FIELD

The present invention relates to a user terminal that includes a hypervisor or other virtual machine host, for example an Automated Teller Machine or other user terminal that is able to perform financial transactions.

### BACKGROUND

ATMs have been around for more than 50 years but have changed slowly during most of that time.

For the first 20 years, ATM architectures were proprietary to the ATM manufacturer, with hardware and software coming from the same vendor. Around 1990, IBM's OS2 made inroads as an operating system for ATMs opening the ATM black box a little with the use of a standard operating system. Windows then took over as OS2 faded, becoming the standard operating environment with Windows NT® first, followed by Windows 2000®, Windows XP®, Windows 7® and now Windows 10®. Most of the world's bank-grade ATMs run some form of Windows® today.

Around the year 2000 there was the introduction of the XFS standard. All the specialized hardware devices inside the ATM, such as cash dispensers and card readers, started to have standard software drivers built to the CEN XFS standard. This gave birth to the multivendor software era that separated software applications from the hardware.

However, each time the ATM operating system required a major version upgrade (e.g. from Windows XP to Windows 7 in 2014), a hardware upgrade was also needed.

The expense to the global industry was huge. It cost billions of dollars to upgrade the world's 3.5 million ATMs.

When Microsoft dropped support for Windows XP, banks had to upgrade all their ATMs to Windows 7.

PC users always have the option of either delaying upgrading their PCs or buying relatively low-cost motherboard upgrades—options which are not available to banks for their ATMs. ATM motherboard upgrades are expensive.

As banks keep ATMs for 10 years or more, many of the older models cannot even be upgraded and need to be replaced. New ATMs can cost between $10,000 and $30,000 depending on their functional capability, plus the cost of physical replacement which can be exorbitant for “through-the-wall” ATMs in a busy location such as central Paris, London or New York. An ATM operating system upgrade brings no direct customer benefit but represents a huge cost just for compliance.

ATMs are subject to regulatory requirements—especially PCI (Payment Card Industry)—that insist there can be no unsupported software in the chain of software components required to run an ATM.

Microsoft is dropping support for Windows 7 and banks will have to upgrade their ATM networks to Windows 10.

Microsoft has announced that W10 will be the “last” Windows iteration. There will not be a Windows 11 or a Windows 12.

The new strategy for Windows is to make OS upgrades and enhancements happen even more frequently than before. Major upgrades will arrive in the form of “LTSCs”—“Long-Term Servicing Channel” packages. Microsoft plans to release LTSCs every 3 years in the future. Thus, ATM hardware might need to be upgraded every 3 years.

The concept of DevOps and advances in automated testing mean that software release cycles are getting quicker all the time. Indeed, daily releases are not unusual in some parts of the software industry. The W10 LTSC channel recommended for ATMs will be Microsoft's slowest cycle for Windows releases. The version of Windows for businesses in general is the SAC (semi-annual channel), which updates much faster (every 6 months) and Microsoft mandates that the updates be deployed. SAC is therefore unlikely to be appropriate for ATMs.

Microsoft may be committed to supporting old hardware with new OS updates, but not all Windows components or associated software come from Microsoft®. Hardware component vendors may not update old software drivers to support new releases of Windows that arrive well after they finish driver development.

This is what causes the support problem with OS upgrades. Software drivers, such as Intel's® chipset drivers, support only the OS versions that are available at the time of release of the chipsets—not new OSs that might be released well after the chipset driver development has been completed.

Microsoft may have a release cycle of 3 years per LTSC and Intel may support two LTSCs per chipset. However, LTSCs may arrive much quicker than every 3 years.

This situation is a problem for the ATM industry. The upgrade cycle in the future may be every 6 years, but it could be as little as every 12 months, depending on the way LTSCs, and support for them, evolve in the future. The root cause is that as software cycles get quicker hardware vendors in the support chain may not wish to support new OS releases with their old hardware components.

However, if the OS is to be changed as regularly as Microsoft sends upgrades, the motherboard will also need to be upgraded along with the OS—at a significant cost to the bank. The alternative is to run an unsupported OS and risk being non-compliant with PCI, alongside very real security risks such as malware (and the associated bad press that always accompanies security breaches).

It is an aim of the present invention is to reduce or avoid the need for hardware upgrades and/or to enable user terminals to remain supported during periods before hardware upgrades occur.

### SUMMARY

In a first aspect there is provided a user terminal apparatus comprising:
a hypervisor or other virtual machine host, operable to provide a virtual machine;
a guest operating system that is hosted within the virtual machine;
a plurality of hardware devices;
a plurality of device drivers associated with the plurality of devices; and at least one application or other software configured to run on the virtual machine to communicate with and/or control one or more of the devices via said guest operating system and via one or more of said device drivers, wherein
said one or more device drivers may comprise device drivers that are supported by the hypervisor or other virtual machine host; and/or
at least some of said hardware devices supported by the hypervisor or other virtual machine host may be unsupported by the guest operating system.

The hypervisor or other virtual machine host may include a host operating system and the device drivers may be supported by the host operating system, optionally a Linux operating system.

At least some of the drivers may comprise substitute drivers provided by the hypervisor or other virtual machine host. Said substitute drivers may comprise drivers for underlying hardware that is not supported by the guest operating system.

Drivers for virtual hardware on the guest operating system may be supported whereas drivers for corresponding physical hardware on the guest operating system would be unsupported, if present.

The terminal apparatus may comprise an automated teller machine (ATM).

At least one or more of the device drivers may be supported under the guest operating system and at least one or more other of the device drivers may comprise substitute device drivers provided by the hypervisor or other virtual machine host, optionally the substitute device drivers being operable under the guest operating system and enabling communication with hardware devices that are unsupported by the guest operating system.

At least some, optionally, each of the hardware devices may be supported by the hypervisor or other virtual machine host, optionally by the host operating system.

The at least one application or other software running on the virtual machine may be operable to install software, on the hypervisor or other virtual machine host, for example by receiving the software from a remote source and passing the software to the hypervisor or other virtual machine host.

The at least one application or other software configured to run on the virtual machine may be configured to control operation of the user terminal apparatus.

The apparatus may be configured to send messages between the at least one application or other software running on the virtual machine and the hardware devices supported by the hypervisor or other virtual machine host.

The at least one application or other software configured to run on the virtual machine may be configured to control operation of a user interaction process that comprises a sequence of actions that comprises receiving user input via at least one of the hardware devices, and performing actions using one or more of the hardware devices in response to the user input. The process may include sending messages between the at least one application or other software running on the virtual machine and the hardware devices supported by the hypervisor or other virtual machine host.

The messages may comprise content, for example audio content and/or visual content and or data for display, for outputting by one or more of the hardware devices. The messages may comprise user data and/or financial data. The messages may comprise instructions, for example instructions for one or more of the hardware devices.

The messages may be sent and/or received via middleware, optionally via at least one XFS component, optionally at least one XFS service provider component, optionally at least one CEN XFS compliant component, and/or via the device drivers.

The application or other software may comprise an ATM application. The user interaction process may comprise at least one of a cash withdrawal process, a cash deposit process, a balance checking process.

The apparatus may be configured to have a normal operating mode in which the plurality of hardware devices are under control of the at least one application or other software running on the virtual machine despite at least some of the hardware devices being unsupported by, or having device drivers that are unsupported by, the guest operating system.

The device drivers that are unsupported by, the guest operating system may comprise device drivers for corresponding physical hardware devices. There may be provided drivers for corresponding virtual hardware, and/or said virtual hardware, and said virtual device drivers and/or virtual hardware may be configured to communicate with said unsupported device drivers (e.g. under the guest operating system) and/or unsupported (e.g. under the guest operating system) hardware devices.

Optionally at least one or more of the plurality of hardware devices, and/or associated drivers, may be not under control of and/or are operate independently of the hypervisor or other virtual machine host or the or a further operating system (for example the host operating system) or software operating under said further operating system.

In the or a normal operating mode the at least one application or other software running on the virtual machine may control communication with a network, optionally including communication between the network and said hypervisor.

Optionally the at least one application or other software running on the virtual machine controls communication between the network and the host operating system of the hypervisor, or software running under said host operating system.

At least in the normal operating mode the apparatus may appear to the network to be operating under the guest operating system; and/or wherein the at least one application or other software controls a network card of the apparatus.

In the or a normal operating mode, the or a host operating system may be a slave of the guest operating system.

The virtual machine may include virtual device drivers and/or virtual devices under the guest operating system.

The virtual device drivers and/or virtual devices under the guest operating system may be configured such that messages sent to the virtual device drivers and/or virtual devices are passed to one or more of the device driver(s) and/or hardware devices supported by the hypervisor or other virtual machine host.

The messages may be sent via middleware to the virtual device drivers, wherein the middleware optionally comprises at least one XFS service provider component.

The apparatus may be configured so that messages are sent using a tunneling process, between:—
the at least one application or other software running on the virtual machine; and
the hardware devices and/or the device drivers supported by the hypervisor or other virtual machine host and/or other software supported by the or a host operating system.

The tunneling process may comprise passing the messages through the hypervisor or other virtual machine host and/or through the or a host operating system, optionally a Linux operating system.

For at least some of the messages, the message or at least some of the content of the message, as sent and as received, may be substantially the same despite passing through the tunneling process.

At least some, optionally all, of the messages, or at least some of the content of the messages, may be substantially unaltered by the tunneling process.

The messages may comprise control messages for controlling operation of one or more of the hardware devices.

The messages may comprise data, optionally monitoring data, user input data or status data, from the hardware device drivers and/or the hardware devices.

The monitoring data, user input data or status data may be sent to the at least one application or other software configured to run on the virtual machine.

The apparatus may comprise at least one communication device that is configured to provide communication via a network and/or with at least one remote device.

The at least one communication device may comprise at least one of said hardware devices, optionally a network card.

The at least one application or other software configured to run on the virtual machine may be configured to control operation of the at least one communication device thereby to control communication via the network.

The application or other software configured to run on the virtual machine may be configured to communicate with the communication device.

The at least one application or other software configured to run on the virtual machine may be configured to establish a communication channel via the communication device with a remote management resource.

The remote management resource may comprise management software running on a remote server. The remote management resource may be configured to manage and/or monitor a plurality of user terminal apparatus, each at different locations.

The apparatus may further comprise at least one bridge between the virtual machine and the hypervisor or other virtual machine host.

The at least one bridge may be between the guest operating system and the or a host operating system

In a further aspect of the invention, which may be provided independently, there is provided an apparatus comprising:
a hypervisor or other virtual machine host, operable to provide a virtual machine,
wherein the hypervisor comprises or is associated with a host operating system;
a guest operating system that is hosted within the virtual machine; wherein at least one of a) or b):
a) the apparatus comprises at least one bridge between the guest operating system and the host operating system and/or hypervisor,
b) the apparatus is configured to provide at least one tunneling process for sending messages between the guest operating system (or software operating under the guest operating system) and the host operating system and/or hypervisor (and/or software operating under the host operating system and/or hypervisor).

The at least one bridge may be provided using the WebSocket protocol.

The at least one bridge may be configured to provide for messages to be sent between the virtual machine and the hypervisor or other virtual machine host.

The messages sent via the at least one bridge may comprise one or more of monitoring data, instructions, control messages for controlling operation of at least one aspect of the hypervisor and/or host operating system and/or software or hardware operating under the host operating system, and/or software updates.

The at least one application or other software configured to run on the virtual machine may comprise at least one monitoring component for monitoring operation of at least part of the user terminal apparatus.

The at least one monitoring component may monitor both at least some operations under the guest operating system, and at least some operations of the hypervisor or other virtual machine host.

The at least one monitoring component may monitor operation of at least one process under the or a host operating system.

The at least one monitoring component may monitor operation of at least one of the hardware devices and/or hardware device drivers.

The at least one monitoring component may be configured to operate under control of the or a remote management resource.

The at least one monitoring component may be configured to pass on monitoring data to the remote management resource and/or may be configured to process the monitoring data locally.

The remote management resource may be responsive to monitoring data sent via the monitoring component to send messages to the virtual machine and/or to the hypervisor or other virtual machine host.

The sending of messages to the hypervisor or other virtual machine host may comprises sending messages to the or a host operating system and/or software operating under said host operating system.

The at least one application or other software running on the virtual machine may be configured to pass messages from the remote management resource intended for the hypervisor or other virtual machine host via the or an at least one bridge.

The at least one application or other software running on the virtual machine may be configured to pass messages intended for the hypervisor or other virtual machine host using said at least one bridge.

The message(s) intended for the hypervisor or other virtual machine host may comprise at least one of: one or more control command, a software update, an executable, a script, debugging or testing software.

The apparatus may comprise firmware and may be configured to perform a boot-up procedure that comprises booting the firmware, then launching the hypervisor or other virtual machine host, then launching the virtual machine and the guest operating system.

The firmware may comprise a basic input output system (BIOS) or a Unified Extensible Firmware Interface (UEFI.) After launch of the virtual machine and the guest operating system, the at least one application or other software may take control of operation of the user terminal apparatus.

The virtual machine host and/or guest operating system may be locked, and the hypervisor or other virtual machine host, optionally the host operating scheme, may be locked.

The virtual machine host and/or guest operating system may be locked using a first encryption scheme, and the hypervisor or other virtual machine host, optionally the host operating scheme, may be locked using a second, different encryption scheme.

The hypervisor or other virtual machine host may be provided directly on hardware of the user terminal apparatus, optionally wherein the hypervisor comprises a bare metal hypervisor.

The hypervisor or other virtual machine host may comprise a Linux® hypervisor. The hypervisor or other virtual machine host may comprise Quick EMULator (QEMU). The hypervisor or other virtual machine host may comprise Kernel-based Virtual Machine (KVM) software.

The user terminal apparatus may comprise a further operating system, optionally a Linux® operating system.

The guest operating system may comprise a Windows® operating system. The guest operating system may comprise Windows 10®.

The apparatus may be one or more of a self-service terminal, an information kiosk, a terminal for providing goods or services to a user, a ticket purchase or dispensing terminal, a food or drink dispensing apparatus.

The devices may comprise at least one of:—a user input device, a keypad device; a button; a touchscreen; a camera; a screen or other display device; a cash dispenser device or other dispenser device; a card reader; a reader for reading a contactless card or fob; a cash accepting device.

The hypervisor may configured to provide at least one further virtual machine.

The virtual machine and the further virtual machine(s) may be configured such that at least some software running on one of the virtual machine and the further virtual machine(s) is able to communicate with at least some software running on the other of the virtual machine and the further virtual machine(s).

The virtual machine and the further virtual machine(s) may be configured such that service(s) running on one of the virtual machine and the further virtual machine(s) are accessible to the other of the virtual machine and the further virtual machine(s).

The services may comprise XFS4IoT services and/or WebSockets may be used to communicate between the virtual machine host and the further virtual machine host(s).

In a further aspect, which may be provided independently, there is provided a method of operating a user terminal apparatus that comprises a plurality of hardware devices, the method comprising:
providing a virtual machine;
hosting a guest operating system by the virtual machine;
providing at least one application or other software configured to run on the virtual machine to communicate with and/or control one or more of the devices via said guest operating system and via one or more device drivers, wherein
said one or more device drivers comprise device drivers that are supported by the hypervisor or other virtual machine host; and
at least some of said hardware devices supported by the hypervisor or other virtual machine host are unsupported by the guest operating system.

In a further aspect, which may be provided independently, there is provided a method of adapting a user terminal that comprises a plurality of hardware devices, the method comprising installing a hypervisor or other virtual machine host, and using the hypervisor or other virtual machine host to provide and/or communicate with a guest operating system and to support one or more of the hardware devices, said one or more of the hardware devices being unsupported under the guest operating system.

In a further aspect, which may be provided independently, there is provided a computer program product comprising computer readable instructions that are operable to perform a method as claimed or described herein.

In a further aspect, which may be provided independently, there is provided an apparatus comprising:
a hypervisor or other virtual machine host, operable to provide a virtual machine;
a guest operating system that is hosted within the virtual machine;
a plurality of devices;
a plurality of device drivers associated with the plurality of devices; and
at least one application or other software configured to run on the virtual machine to communicate with and/or control one or more of the devices via said guest operating system and via one or more of said device drivers, wherein
said one or more device drivers comprise device drivers that are supported by the hypervisor or other virtual machine host and that are unsupported by the guest operating system.

In a further aspect, which be provided independently, there is provided the use of a hypervisor as a host operating system in a computer system such that it can host a guest operating system in a virtual machine to preserve the ability of existing user software to run within the guest operating system; using the hypervisor to provide substitute device drivers for underlying hardware that is no longer supported by the guest operating system.

In a further aspect of the invention, which may be provided independently, there is provided a method comprising:
providing a virtual machine;
providing a guest operating system that is hosted within the virtual machine; wherein at least one of a) or b):

a) the method comprises providing at least one bridge between the guest operating system and a host operating system and/or hypervisor,

b) the method comprises performing at least one tunneling process for sending messages between the guest operating system (or software operating under the guest operating system) and the host operating system and/or hypervisor (and/or software operating under the host operating system and/or hypervisor).

Features in one aspect may be provided as features in any other aspect. According to further aspects, any one of apparatus, method or computer program product features may be provided as any one other of apparatus, method or computer program product features.

### BRIEF DESCRIPTION OF THE DRAWINGS

Embodiments of the invention are now described, by way of non-limiting example, and are illustrated in the following figures, in which:—

FIG. 1 is a schematic illustration of a user terminal according to an embodiment;

FIG. 2 is a schematic illustration of ATM software architecture inside an ATM with OS virtualization technology according to an embodiment;

FIG. 3 is a schematic illustration of ATM software architecture inside an ATM with OS virtualization technology according to an embodiment;

FIG. 4 is a flow diagram showing preparation of an OS virtualization (Hypervisor) system according to an embodiment;

FIG. 5 is a schematic illustration of ATM software architecture inside an ATM with OS virtualization technology showing transmission of messages according to an embodiment;

FIG. 6 is a schematic illustration of a different conceptual view of ATM software architecture inside an ATM with OS virtualization technology according to an embodiment;

FIG. 7 is a schematic illustration of ATM software architecture inside an ATM with OS virtualization technology from a guest operating system perspective according to an embodiment;

FIG. 8 is a flow diagram showing sending of messages to hardware devices using the OS virtualization (Hypervisor) system according to an embodiment;

FIG. 9 is a flow diagram showing sending of messages via a bridge between the host and guest operating systems using the OS virtualization (Hypervisor) system according to an embodiment;

FIG. 10 is a schematic illustration of ATM software architecture inside an ATM with OS virtualization technology including software applications according to an embodiment; and

FIG. 11 is a schematic illustration of ATM software architecture inside an ATM with OS virtualization technology including software applications according to an embodiment.

### DETAILED DESCRIPTION OF EMBODIMENTS

Embodiments can be implemented, for example, in a variety of user terminals, for example ATMs or other types of user terminals that can be used for the purchase and/or dispensing of goods and services.

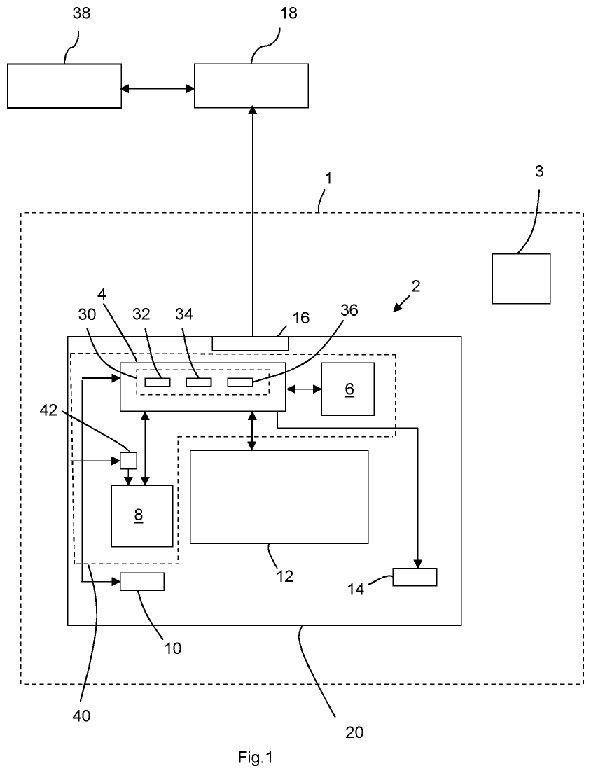

A user terminal 2 in accordance with an embodiment is illustrated schematically in FIG. 1. The user terminal 2 includes a processor 4 connected to a data store 6. The processor 4 is also connected to an encryption apparatus in the form of an encrypting pin pad (EPP) 8, a card reader device 10, a display 12 and a printer 14. The user terminal also includes a cash store, for example a safe, and a cash dispensing mechanism for dispensing cash from the cash store. The cash store and the cash handling mechanism are not shown in FIG. 1 for clarity.

In the embodiment of FIG. 1, the processor comprises a Windows PC core. The data store 6 comprises a hard disk, the card reader device 10 is an Omron V2BF-01JS-AP1 card reader, the display 12 is a touchscreen display and the printer 14 is an Epson M-T532, MB520. The EPP 8 comprises a PCI-compliant number pad and is operable to securely receive a PIN entered by a user.

Although particular component types and models are included in the embodiment of FIG. 1, any suitable component types and models may be used in alternative embodiments.

The user terminal 2 also includes a communication interface 16, for example comprising a network card, that is configured to enable the user terminal to transmit messages to and receive messages from a server 18 associated with the user terminal network operator responsible for installation and operation of the user terminal 2. The server 18 may provide a remote management resource and/or may provide a connection to a, or a further, remote management for resource such as further server 38 shown in FIG. 1 by way of illustrative example. The messages are transmitted and received via a secure network connection in accordance with known banking protocols.

The user terminal network operator may be a financial institution, for example a bank. The messages sent between the user terminal 2 and the server 18 may relate to a particular transaction, and may comprise for example authorisation messages or messages comprising instructions to credit or debit an account in relation to a transaction conducted by a user using user terminal 2. In addition, the server 18 can send software installation or update messages that comprise software components for automatic installation at the user terminal 2. The user terminal 2 is also able to send management information to the server 18, comprising for example data representing usage of the user terminal during a particular period, or fault monitoring data.

In operation, the processor 4 controls operation of the other components of the user terminal 2, under control of application components running on the processor. Upon power-up of the user terminal 2 a basic input-output system (BIOS) is booted from non-volatile storage (not shown) included in the processor 4, and a Windows 10 operating system and application components are installed from the data store 6 by the processor 4 to form a user terminal processing system.

The application components include various application modules 32, 34, 36 that form part of a user terminal application 30 that controls operations relating to user interaction with the user terminal.

The user terminal application 30 forms part of an application layer and is provided under an XFS-compatible application environment, which may be a hardware-agnostic application environment such as KAL Kalignite® or a manufacturer-specific application environment.

The software architecture of the user terminal 2 includes various other layers, in accordance with known ATM-type device architectures, including an XFS layer that mediates between the application layer and a hardware device layer. The hardware device layer includes various hardware-specific drivers for controlling operation of the various hardware components of the user terminal 2. It is a feature of the embodiment that the user terminal includes a hypervisor that provides a guest operating system, the hypervisor being such as to support hardware devices that would not otherwise be supported under the guest operating system. Further details of hypervisor arrangements according to embodiments are provided below.

In operation, the user terminal application 30 controls operation of the user terminal 2, including operations associated with performance of a financial transaction by a user such as, for example, reading of the user's card, reading of a user's PIN, receipt and processing of a user's data such as account balance, overdraft limit and withdrawal limit from server 18, and display of a sequence of display screens on the display 12.

In FIG. 1, three application modules 32, 34 and 36 forming part of the application 30 are shown. The application module 32 controls communication with the server 18, and the processing of data associated with a transaction, including user data received from the server 18. The application module 34 controls the display of transaction screens on the display 12, including selecting and outputting the appropriate transaction screen for a particular point in a transaction process. The application module 36 controls the output of cash to a user via the cash dispensing mechanism at the end of the transaction process.

Whilst particular modules 32, 34, 36 are described in relation to FIG. 1, in alternative embodiments functionality of one or more of those modules can be provided by a single module or other component, or functionality provided by a single module can be provided by two or more modules or other components in combination.

User terminal 2 includes security features such as an outer housing 20 and an inner housing 40 and a tamper detection device 42 to provide a means for triggering a tamper detection system associated with the EPP.

In other embodiments, the user terminal may not have the same set up and components as shown in FIG. 1, e.g. may have different security features or arrangement.

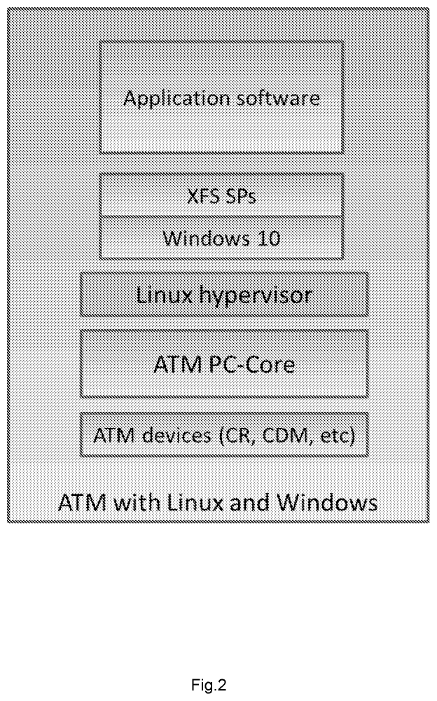

FIG. 2 shows a schematic illustration of an embodiment of the ATM software architecture inside an ATM (user terminal 2) with OS (operating system) virtualization technology.

A hypervisor runs on the bare metal PC-core, Windows 10 ® runs as a guest operating system on top of the hypervisor, and application software along with XFS SPs from a hardware vendor runs inside a Windows virtual machine.

The ATM devices may comprise at least one of:—a user input device, a keypad device; a button; a touchscreen; a camera; a screen or other display device; a cash dispenser device or other dispenser device (CDM); a card reader (CR); a reader for reading a contactless card or fob etc.

The use of the hypervisor can provide for significantly enhanced functionality of the ATM or other user terminal. Amongst other things, it can allow hardware devices that would otherwise be unsupported by a guest operating system to be supported whilst also allowing a required guest operating system to be used and can thus, for example, avoid, delay or provide flexibility in replacing or updating hardware devices, whilst maintaining or enhancing functionality of the user terminal and allowing for operating system upgdrades or changes. Some general information concerning hypervisors and their use in this context, and some installation requirements for certain embodiments are now provided, before returning to description of architectures and functionalities of particular embodiments.

Hypervisors allow multiple operating systems to run on the same hardware server. There is an example hypervisor from VMware. Global datacenters run hypervisors from VMware®, Red Hat® etc to isolate the hardware from the operating environment. A Hypervisor may be a Linux Hypervisor (i.e. may include a Linux® operating system).

For example, it would be possible to run, say, Windows XP and Windows 7 simultaneously as guest operating systems on a VMware host-OS. They also allow servers to be remotely controlled and managed using the hypervisor. A running system can be frozen in its tracks, moved to a new hardware server, and restarted from where it left off, as if nothing happened in between.

Virtualization allows a guest OS to run on a host OS. Hardware virtualization in CPUs allows the guest OS executables to run natively on the CPU, but catch system calls so they can be processed by the correct OS. Application software in the guest OS runs as if it had the whole CPU to itself without discernible impact on performance.

In testing, performance impact was discovered to be only around 2% for a virtualized ATM running both Windows and Linux when compared with running Windows natively on the hardware without virtualization.

All Linux software drivers, including Intel's chipset drivers, are open source under Linux. That means that companies such as Wind River and Red Hat from the Linux ecosystem have access to that source code and can provide support on a commercial basis.

Although Linux can solve the long-term software support problem, it has a huge disadvantage compared with Windows in that banks have invested billions of dollars into ATM software that runs on Windows. The migration cost would be enormous.

There is a technical hurdle in addition to the financial one. ATMs have hardware drivers that use the XFS standard that are implemented on Windows only. Even if a bank wished to migrate their software stack to Linux, it could not do that unless the hardware supplier was also willing to migrate their XFS drivers to Linux. Currently, no drivers exist for ATMs from the major vendors on Linux.

Linux supports a hypervisor technology called QEMU (Quick EMUlator). QEMU runs in conjunction with KVM (Kernel-based Virtual Machine) to exploit the virtualization hardware acceleration on Linux and is able to present an interface to Windows 10 to run as a guest operating system on Linux. The hardware drivers for the motherboard now come from the Linux kernel, but the application environment runs under Windows. Support for QEMU, KVM and the Linux drivers comes from the Linux community and companies such as Red Hat and Wind River. The Linux part can therefore be supported for any length of time provided the commercial conditions work for the Linux companies.

In embodiments, Windows may sit atop of Linux and may be updated as often as Microsoft and the banks wish to update it- and all of that can happen remotely online, without an onsite visit to the ATMs. This solves the problem with upgrades. It eliminates the need for enforced hardware upgrades caused by Windows upgrades or LTSCs, and banks can stay completely up to date and run the latest versions of all software.

At a conceptual level, a virtualized software solution looks exactly like a software stack, but with the addition of a hypervisor between the Windows OS and the hardware—see Linux hypervisor in FIG. 2. Some prerequisites according to some embodiments are presented here.

Although hypervisors can run on ATMs that do not have built-in hardware support for virtualization by using software emulation, this may be too slow for production use. Here is a list of prerequisites for virtualization of ATMs according to certain embodiments:
1. The first requirement is “VT-X” and “VT-D” on Intel motherboards, and “AMD-V” on AMD motherboards. As CPUs with these hardware capabilities began to appear around 2006, any ATM older than that will not be able to support virtualization without a significant performance degradation. However, it is likely that ATMs with these capabilities did not appear until well after 2006 as ATM hardware vendors often used older stocks of CPUs over long a period.
2. The virtualization capability on CPUs that support it can be disabled by a BIOS setting. This would require an onsite visit to change this setting adding cost to implementing a hypervisor solution. Some ATM hardware vendors have BIOS management tools that can be used remotely. It may be recommended to first test the BIOS configuration and then change that configuration remotely to enable virtualization. Newer ATMs are most likely to have this option already enabled by default.
3. Next banks will need to select a hypervisor vendor, e.g. Red Hat, VMware and Wind River. Microsoft, too, has a hypervisor called Hyper V which is a standard part of Windows and could theoretically work, but it suffers from the same drawback as Windows itself. As the driver source code is not available for third-party device drivers in Windows, unsupported drivers with Hyper V have no way of being supported by Microsoft or someone else.
4. Finally, it needs to be checked that the ATM hardware and software vendors will support their software applications and drivers in a virtualized environment. For example, if the ATM software vendor is KAL, it needs to be checked that KAL will support a virtualized environment and it needs to be checked that the ATM hardware vendor will support their XFS SPs in a virtualized environment. Banks need to ensure that virtualization support is built into all future bank RFPs. That is what happened in the year 2000 with XFS when Banks mandated XFS support from all vendors.

An implementation project may also need to be completed:
1. The new hypervisor solution may need to be tested to ensure that all the test scripts that were used to acceptance test the current solution continue to work when the OS is virtualized—it should.
2. The ATM security lockdown may need to be reviewed. The new environment changes the security envelope—the hypervisor as well as the Windows environment may need to be locked down.
3. The ATM monitoring system may need to be reviewed. Ideally, the hypervisor software should be monitored too, along with the rest of the system.
4. The software distribution mechanism may need to be reviewed. Ideally, the changeover should happen completely with remote software distribution, without the need to send a technician to the ATM. The software distribution system may need to be able to deliver patches and updates to the hypervisor software, as well as to Windows and the Application—all ideally online (or via DVD if that is the only option available).

Once these steps have been completed the system may be ready to go live.

There is an extra software component in the ATM software stack for which banks may now need to have a support contract. Hypervisor support may be needed to be added to the list. The hypervisor vendor may need to provide:
Commitment to support ATM hardware on a long-term basis—at least 10 years if not more.
Support for motherboard device drivers under Linux so that as 3^{rd} party software drivers under Windows for that hardware go out of maintenance under new LTSCs, they can be substituted using Linux open-source drivers via virtualization.
Support for Intel and AMD chipsets for as far back as the hypervisor vendors can provide so that older ATMs on the network can be supported.
Support for future LTSCs from Microsoft as they arrive, being mindful of potential software driver related problems for old hardware as pointed out above.

Ideally, the ATM Industry may desire a single global hypervisor release from each of the vendors to support all ATM motherboard models worldwide.

Embodiments provide advantages of reducing the expense and complexity of upgrading banks' ATM software and hardware, e.g. when support for Windows 7 ends and is replaced by Windows 10.

The shift from Windows XP to Windows 7 in 2014 cost the global industry billions of dollars because upgrading the ATM operating system also meant upgrading the hardware. Banks encounter the very same issue again when they must upgrade to Windows 10.

OS-Virtualization provides a hypervisor to separate the hardware motherboard from the operating system so that software drivers that are unsupported under Windows 10 can be supported by the hypervisor software instead.

This hypervisor technology may remove the need to upgrade current hardware when ATMs move to Windows 10, protecting the investments made by 20,000 banks worldwide in software and hardware, while remaining compliant with PCI.

This technology has advantages when migrating to Windows 10, as well as when managing future Long-Term Servicing Channel (LTSC) software releases under Windows 10, which could require even more frequent hardware upgrades.

There is an option to simply not upgrade the OS and continue to run previous Windows OS (e.g. Windows XP) on ATMs. This may be a risky strategy. Not only is it not PCI compliant to run unsupported software, it also exposes the bank and its customers to potential malware and cyber-attacks, as vulnerabilities in unsupported operating systems get exploited by criminals. Thus, this option has big disadvantages.

However, there is an alternative to “not upgrading” ATMs that can potentially work with Windows 10 and subsequent releases of LTSCs.

In this scenario, it is assumed that a bank does initially upgrade their ATMs to Windows 10 as required. The version of Windows 10 in 2019 is called Windows 10 LTSC 1809 and it works in conjunction with a chipset that supports that LTSC. Microsoft, Intel and the ATM industry may support that combination for 10 years. That might appear to solve the upgrade dilemma, but in fact it doesn't for these reasons:
New Windows 10 LTSCs as they arrive cannot be run on that 2019 ATM—over the 10-year life span the ATM would need to run the original LTSC.
As an example, a large bank with say 10,000 ATMs would replace 10% of its estate each year as the ATMs age. Each year the bank might purchase 1000 new ATMs that would get delivered with the latest LTSC from Microsoft and the current chipset from Intel. In 2023, for example, they would receive LTSC 23XX. While those new ATMs will run LTSC 23XX, the old ATMs converted in 2019 can only run LTSC 1809. After 10 years, the ATM network would potentially have 10 different LTSC plus chipset combinations running different OS versions and different feature capabilities.
Although each ATM would have a supported software stack over a 10-year period, this would be achieved by not upgrading the OS as LTSCs arrive, resulting in a fragmented network with potentially many different OS versions across the network.

This may be an untenable scenario for most banks.

Another option may be whether there could be a special support regime for e.g. Intel chipset drivers for the ATM industry. For example, special paid long-term support for Intel drivers for the ATM industry and source code licensing to the ATMIA of old drivers. However, as ATMs are a relatively small industry these options are unlikely to be viable.

Linux has been an option for ATMs for a very long time. However, the global ATM industry is a relatively small market with just 3.5 m ATMs worldwide. Supporting a fragmented market with both Linux and Windows is unlikely to be commercially feasible for the vendors. Globally there are approximately 20,000 banks. The decision of which OS to run on ATMs is fundamentally made by the bank—not by the vendors. Banks will not allow an OS for which they do not have a policy to be connected to their internal network.

Migration to complete Linux software stack would need to contend with a very long period of market fragmentation. ATM manufacturers have not been willing so far to invest in supporting both Linux and Windows on their ATMs through such a transition period. As the XFS drivers are controlled by the manufacturers, if these drivers are not ported to Linux it is then impossible for any software vendor to run a Linux application on an ATM.

As mentioned above, Linux may solve the PCI problem for banks. However, there is a large cost to migrate all the world's ATM software at thousands of banks from Windows to Linux.

Embodiments of virtualization may solve a dilemma for ATM deployers by breaking the link between Windows OS upgrades and PC-core hardware upgrades. Virtualization allows the OS and the hardware to be upgraded as necessary and thereby removes the huge disruption to ATM networks that will be caused when Windows 7 or other Windows OS go out of support.

Embodiments of this concept also may have advantages for hardware vendors. Hardware vendors often purchase motherboards and chipsets in large quantities only to discover that a new OS upgrade makes their old hardware stock worthless. As virtualization breaks the tight link between motherboards and operating systems, this may save costs for ATM manufacturers too.

OS-Virtualisation provides the way forward to eliminate the costly, expensive and time-consuming process of banks having to continuously upgrade ATM fleets to support a new operating system. It does not remove the need to upgrade hardware forever—but it does remove the need to upgrade ATMs just because of an OS update. Banks will still need to upgrade their PC-cores either because they are too old, or too slow, or because they wish to use future CPU capabilities to deliver exciting new services to their customers.

Banks may mandate virtualization support in all their RFPs for ATM software and ATM hardware.

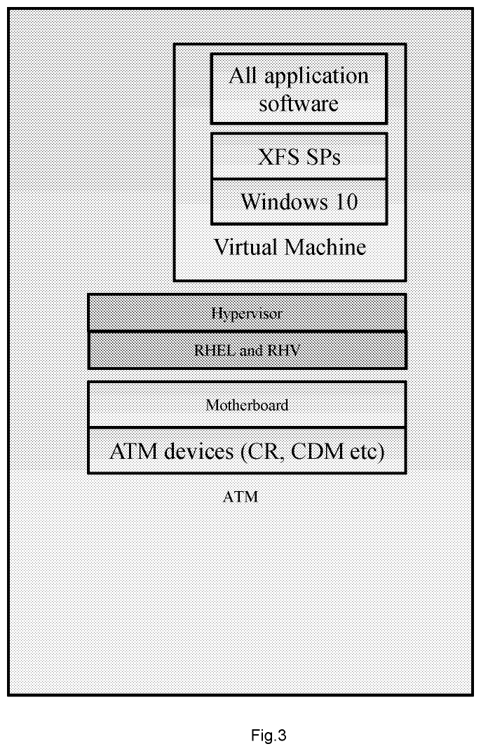

Considering a particular embodiment, FIG. 3 shows the schematic illustration of the embodiment of the ATM software architecture inside an ATM (user terminal 2) with OS (operating system) virtualization technology with additional detail.

In FIG. 3, the Hypervisor is shown as the Red Hat Linux (RHEL—Red Hat Enterprise Linux and RHV—Red Hat Virtualization) optimized for ATMs, which includes virtualization components such as KVM (Kernel-based Virtual Machine) and QEMU (Quick EMUlator). KVM is a virtualization module in the Linux kernel that allows the kernel to function as a hypervisor and QEMU is a hosted virtual machine monitor.

The Hypervisor may be a Kalignite hypervisor. The Hypervisor may also include system management components on the Linux side as well as on the Windows side as will be explained in more detail.

In FIG. 3, it is shown that Windows 10, XFS SPs and all application software are within the Virtual Machine (VM) which is hosted by the (Linux) Hypervisor.

Linux is installed first on the ATM and a virtual machine (VM) is created with Windows 10 inside that VM. The rest of the ATM software stack such as the hardware vendor's XFS platform, the ATM application and all other application and system software required by the bank are installed inside the VM.

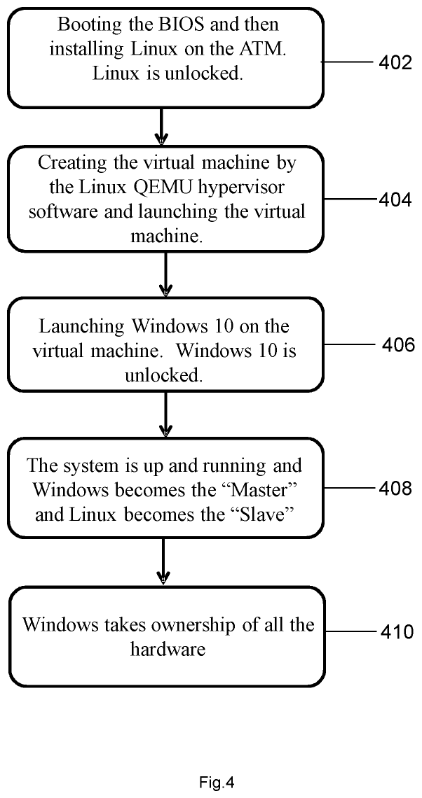

FIG. 4 shows a flow diagram of the preparation of the OS virtualization (Hypervisor) system. In step 402, a basic input output system (BIOS) performs a boot up procedure that comprises booting the BIOS and then Linux is installed on the ATM. More generally, the bootup procedure uses firmware which may include BIOS or UEFI (Unified Extensible Firmware Interface). Linux runs natively on the hardware. For security, Linux is locked and is unlocked during the boot up procedure.

The hypervisor environment may be created by source-controlled installation code. There may be no manual steps involved, either at install time or at build time. For example, there may be no manual creation of the gold image. The gold image may be created automatically during the build process. Gold-image files may be created at build time for each of the partitions in the production environment. A gold image may be considered to be a byte by byte copy of the data that will be installed on the machine. Installation then just involves copying that image to the target machine without any changes.

In step 404, the virtual machine is created by the Linux QEMU hypervisor software and the virtual machine is launched. The host may run RedHat Enterprise Linux (RHEL), or if required RedHat Virtualization (RHV). The starting point for the RHEL setup will be the ‘minimal’ configuration—this is the smallest set of components possible to start to. Extra components, modules and packages may be added to this as required.

In step 406, Windows 10 is launched on the VM. Windows 10 and all the enterprise software required by the bank is inside the VM. This may be compared with running applications in a virtualized environment in a datacenter but, here, the virtualization happens inside the ATM. For security, Windows 10 is locked and is unlocked during the boot up procedure.

In step 408, the system is up and running and Windows becomes the “Master” and Linux becomes the “Slave”. In other words, the architecture “flips around”. Although Linux is the “Host OS” and Windows is the “Guest OS” at bootup, the roles are then reversed.

The hardware devices may be completely controlled by the Windows guest OS, including complete control of the network card to the extent that it looks like a Windows machine on the network. This is different from the normal use of a Hypervisor, e.g. in a datacentre.

In step 410, Windows takes ownership of all the hardware. The ATM devices (cash dispenser etc) are “passed-through” to Windows and are “owned” by Windows. The network card, TPM (Trusted Platform Module) and display are similarly owned by Windows. The aim is for the physical display to be indistinguishable from a system with the OS running natively on the hardware. The display should be able to run full screen graphics and any other type of normal UI, such as animated UI components.

The ATM becomes a Windows ATM with a Linux software sub-component within it. Linux has no access to these devices, nor the network after start-up.

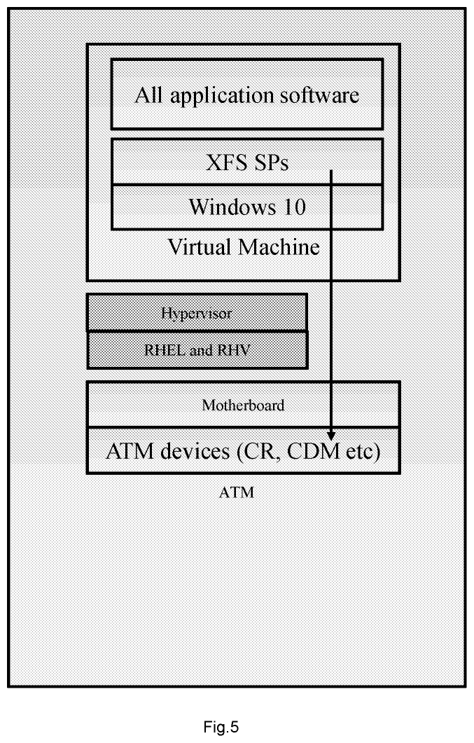

FIG. 5 shows a schematic illustration of the ATM software architecture with Windows having taken ownership of the hardware. That is, the arrow shows messages from the application software being passed in XFS format to the Windows OS and then communicated to the ATM devices.

The ATM comprises Linux (i.e. a host operating system) to provide the virtual machine and Windows 10 (i.e. a guest operating system) that is hosted within the virtual machine. The ATM also comprises hardware devices and device drivers associated with the devices. The ATM also includes application software configured to run on the virtual machine to communicate with and/or control the devices via Windows 10 and via the device drivers. The device drivers may be supported by Linux. In other embodiments, different host and guest operating systems may be used.

The ATM is configured to send messages between the application software running on the virtual machine and the device drivers or other software supported by Linux.

The virtual machine (VM) includes virtual device drivers and/or virtual devices under Windows 10. The virtual device drivers and/or virtual devices under Windows 10 are configured such that messages sent to the virtual device drivers and/or virtual devices are passed to the device drivers and/or physical hardware devices supported by Linux. The messages may be sent via middleware to the virtual device drivers. The middleware may comprise at least one XFS service provider component.

The application software may control operation of a user interaction process. The user interaction process may include a sequence of actions that comprises receiving user input via at least one of the hardware devices, and performing actions using one or more of the hardware devices in response to the user input. The process may include sending messages between the application software running on the virtual machine and the device drivers supported by Linux.

The messages may comprise content, for example audio content and/or visual content and or data for display, for outputting by one or more of the hardware devices. The messages may comprise user data and/or financial data. The messages may comprise instructions, for example instructions for one or more of the hardware devices.

The messages may be sent and/or received via middleware (e.g. via an XFS service provider component).

The application software includes an ATM application. The user interaction process may comprise at least one of a cash withdrawal process, a cash deposit process, a balance checking process.

In an operating mode of the apparatus, optionally the normal operating mode of the apparatus, the hardware devices may be under control of the application software running on the virtual machine, and under Windows 10. The hardware devices may be not under control of and/or are operated independently of Linux or software operating under Linux.

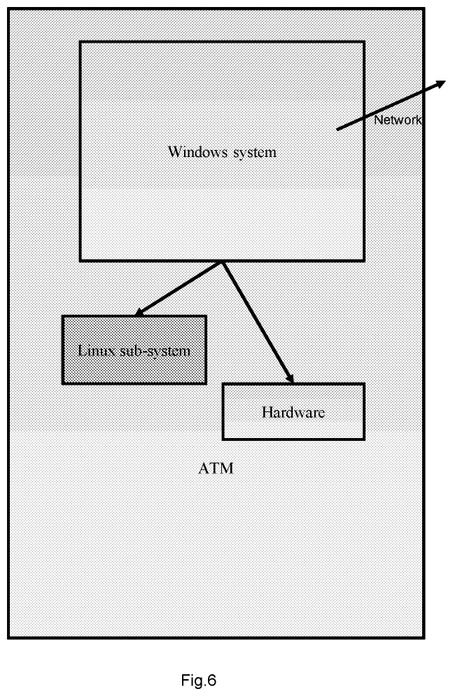

FIG. 6 shows a schematic illustration of the ATM software architecture in a different conceptual view in order to assist understanding of the Hypervisor. The ATM running the Hypervisor may be considered as a Windows system with an embedded Linux sub-component.

Windows controls the hardware as well as the network connection, and even controls Linux too.

Linux has no access to any of the devices nor to the network after boot up. This improves security as Linux is removed from the attack surface for potential attacks by e.g. hackers. In other words, it is not possible to gain access to Linux through the network. Since only Windows controls and manages the complete environment, this will provide increased confidence in the security for the banks.

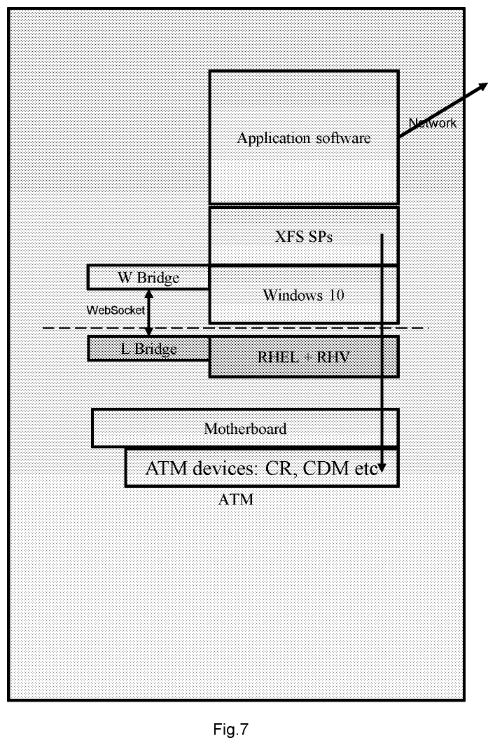

FIG. 7 shows a schematic illustration of the ATM software architecture showing an architectural perspective from the Windows side.

The ATM application suite sits at the top and connects to the XFS SPs. The hardware vendor's XFS platform runs inside the Windows VM and owns all of the XFS devices after boot. The SPs tunnel-through to the hardware devices such as the cash dispenser and the card reader. Linux takes no part in this—other than to sustain the tunnel.

In other words, the ATM is configured so that the messages may be sent using a tunneling process, between the at least one application or other software running on Windows 10 in the virtual machine and the hardware devices and/or the device drivers supported by Linux and/or other software supported by Linux.

The tunneling process comprises passing the messages through Linux. For at least some of the messages, the message or at least some of the content of the message, as sent and as received, may be substantially the same despite passing through the tunneling process. At least some, optionally all, of the messages, or at least some of the content of the messages, may be substantially unaltered by the tunneling process.

The financial hardware devices such as a cash dispenser device or other dispenser device (CDM); a card reader (CR); a reader for reading a contactless card or fob etc are connected in this way. For example, these hardware devices may be connected by a USB. A USB controller may be virtualized and the application software may send a message by using Windows 10 to tunnel through Linux to the device connected by the USB. The message is not changed by the virtual USB device.

The other hardware devices (which are not financial) such as a network card, TPM, user input device, a keypad device; a button; a touchscreen; a camera; a screen or other display device are connected in another way. For example, the application software may send a message to these hardware devices through Windows 10 and through Linux. There may be a virtualized device driver and a virtualized device presented by the VM in Windows 10. Windows 10 may interact with this virtualized device as if it were real hardware. However, the virtualized device passes the message through the hypervisor (i.e. through Linux) to the device driver of the hardware device. Thus, the message is passed through to the hardware device.

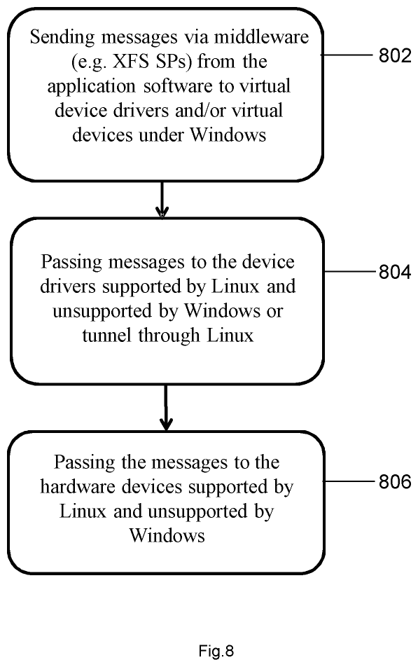

FIG. 8 shows a flow diagram of sending messages to the hardware devices using the hypervisor. In step 802, messages are sent via middleware (e.g. XFS SPs) to virtual device drivers and/or virtual devices under Windows 10. In step 804, messages are passed to the device drivers supported by Linux and unsupported by Windows or messages tunnel through Linux. In step 806, the messages are passed to the hardware devices supported by Linux and unsupported by Windows. In other embodiments some of the device drivers and/or devices may be supported by Windows.

Linux (the host OS) can host Windows (a guest OS) in a virtual machine to preserve the ability of existing user software to run within Windows. Linux may be used to provide substitute device drivers for underlying hardware that is no longer supported by Windows.

Data may be sent from the application software through a network. The ATM may include a communication device that is configured to provide communication via the network and/or with a remote device. The communication device may be one of the hardware devices. The communication device may be a network card.

The application software configured to run on the virtual machine is configured to control operation of the communication device to control communication via the network. This may be via the tunneling process.

There may be at least one physical network connection on the physical machine. All network connections will be passed through to Windows and will not be accessible to Linux. There will be no direct connection from Linux to the network. Linux will not have a network connection for the physical network. There may be a virtual network between Linux and Windows, with relevant network connections on each side.

The virtual network will have a static IP configuration in the non-routed range. This configuration must be adjustable, since there may be a collision between existing network configuration and this static configuration. All remote control of the host system will be handled as commands to the guest system which will implement them as some type of call to an agent on the host system.

The Kalignite Hypervisor will have Agent processes running continuously on the RHEL host. These will perform any actions required on the host as required by the Kalignite Hypervisor system. Actions will be typically triggered by components on the Guest system (including the KTC Client). There may also be a permanently running Hypervisor Client on the Guest system which will take care of Hypervisor actions on the Guest triggered from the host, such as writing to the Kalignite Trace and performing FE handling.

The API (application programming interface) may be via a web socket connection on a private virtual network between the guest and the host.

The only mechanism for making any changes to the host environment may be through RPM packages installed using YUM from the elevated agent. Agent to root agent message API will not contain a generic command message. There will be no way to instruct the Root Agent to perform an untrusted command. It must just be a package name and the root agent will automatically check and install that named package. Hence the package must be signed to get root access.

The application software may be configured to establish a communication channel via the communication device with a remote management resource. The remote management resource may comprise management software running on a remote server. The remote management resource may be configured to manage and/or monitor a plurality of user terminal apparatus, each at different locations.

On the left hand side of FIG. 7 are a pair of components which form part of the Kalignite Hypervisor. The components include a Windows (W) Bridge on the Windows 10 side and a Linux (L) Bridge on the Linux side. The W Bridge and the L Bridge are connected via an internal WebSocket which is bi-directional (see two headed arrow), and forms a bridge. The Kalignite Hypervisor Windows-Bridge and the Linux-Bridge together control the Windows/Linux relationship.

The bridge is configured to provide for messages to be sent between Windows and Linux. The messages sent via the bridge may include monitoring data, instructions, control and software updates. Hypervisors are normally used to stop the VM (virtual machine) from interacting with the host OS or the hardware directly. However, in embodiments, the host OS (Linux) is controlled by the guest OS (Windows) via the bridge.

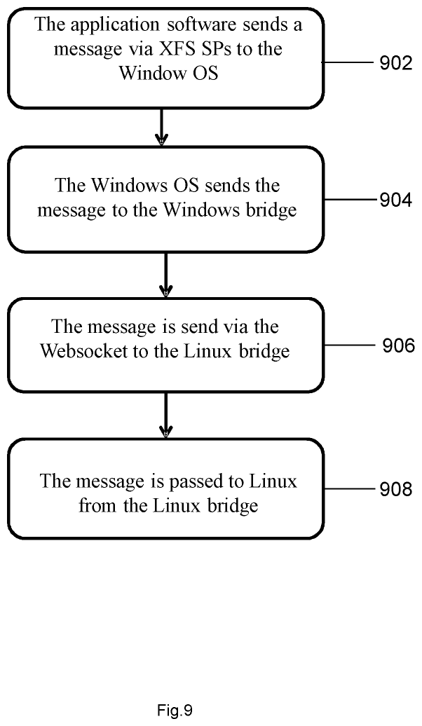

FIG. 9 shows a flow diagram of messages being sent via the bridge. In step 902, the application software sends a message via XFS SPs to the Window OS. In step 904, the Windows OS sends this to the Windows bridge. In step 906, the message is sent via the Websocket to the Linux bridge. In step 908, the message is passed to Linux from the Linux bridge, e.g. for interacting with or monitoring the hardware devices.

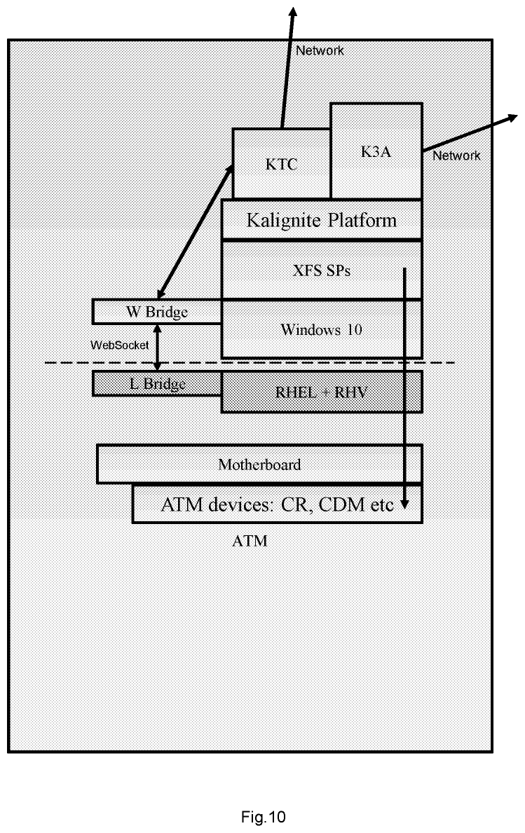

FIG. 10 shows a schematic illustration of the ATM software architecture including the Kalignite software suite on a Kalignite Hypervisor system. K3A is the application software whilst KTC manages the system. The Kalignite Platform provides multi-vendor capability and controls the ATM XFS hardware devices.

KTC also connects to the Kalignite Hypervisor Windows (W) Bridge directly (see arrow). KTC monitors and manages the Linux side with help from the bridge components. The Linux (L) Bridge collects monitoring information and passes it via the Windows Bridge to KTC. KTC receives software packages, verifies and extracts the Linux RPMs and Kalignite Linux packages, and passes them across, where they are then installed by the Bridge and by Linux.

KTC configured to run on the virtual machine comprises at least one monitoring component for monitoring operation of at least part of the ATM. The monitoring component monitors both at least some operations under Windows, and at least some operations of Linux. This may include the operation of the hardware devices or hardware drivers. The monitoring component may be configured to operate under control of the remote management resource. This may be by passing on monitoring data to the remote management resource and/or processing the monitoring data locally.

The remote management resource is responsive to monitoring data sent via the monitoring component to send messages to the virtual machine and/or to Linux or software operating under Linux. K3A or other application software may pass messages (e.g. from the remote management resource) to Linux using the bridge. The messages may include a control command, a software update, an executable, a script, debugging or testing software. K3A may be operable to install software, for instance a software update, on Linux by receiving the software from a remote source and passing the software to Linux.

Normally, the Hypervisor is used to keep the guest OS isolated but, in embodiments, the guest OS (Windows) is used e.g. to install software etc on the host OS (Linux). The reason that the guest OS (Windows) does not do everything is that some of the hardware devices are only supported by the host OS (Linux).

The Kalignite Hypervisor environment may be managed and monitored from KTC. As far as possible this will be transparent to the operators, but certain things will need to be monitored for security, and for issue fixing.

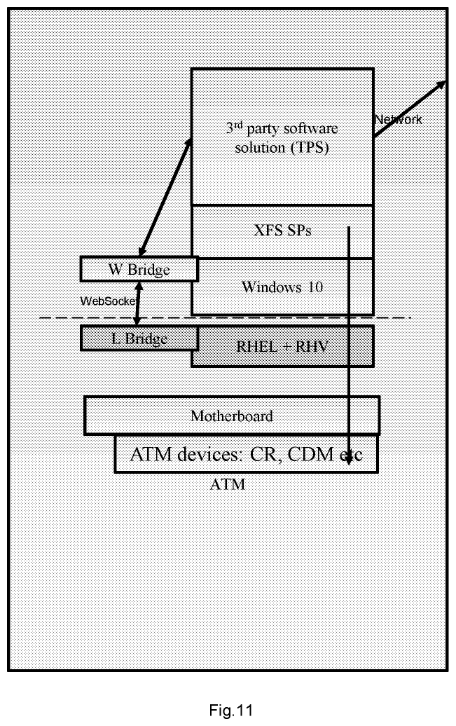

FIG. 11 shows a schematic illustration of the ATM software with non KAL applications (i.e. third party applications) and the Kalignite Hypervisor. The third-party solution (TPS) contains an application plus management components.

The TPS would connect to the XFS SPs as normal to drive the ATM devices. The TPS would connect to the Open-API of the Kalignite Hypervisor Windows (W) Bridge to monitor and manage the Linux side. The Linux (L) Bridge collects monitoring information and passes it via the Windows Bridge to the TPS.

The TPS should deliver software packages destined for the Linux side to an agreed location on the Windows side. These are then picked up by the Kalignite Hypervisor Windows (W) Bridge, are passed across, and are then installed by the Kalignite Hypervisor Linux (L) bridge and Linux. Packages must be signed.

To secure the system using the Kalignite Hypervisor (whether using the KAL platform (FIG. 10) or TPS (FIG. 11)), Windows must be secured “as normal” and Linux has to be secured in addition.

The Windows system and the Linux sub-system may be secured independently. The security of the Hypervisor environment should be at least as good as a bare metal machine. The Hypervisor is a high value target because an attacker with control of the Hypervisor can directly access and change the memory and hard disk of the main (host) OS, stealing data and injecting malware. It would be very difficult to defend the guest OS against this type of attack internally. So, the host OS must be fully protected at all levels.

To secure Windows, Kalignite security lockdown for Windows may be used. This consists of several technologies: DeviceGuard, Bitlocker, Applocker, Windows firewall and more. The network architecture only permits external network access to the guest—the host (Linux) has no external network access. The only network access for the host (Linux) is directly to the guest (Windows), so the network protection can be very simple.

To secure Linux, the primary technologies used may be LUKS disk encryption and SELinux. To protect against offline attacks the HDD should be encrypted at the partition level. This may be achieved with LUKS hard drive encryption. LUKS should be applied at the partition level but can't be applied to all partitions since certain partitions need to be unencrypted to let the system boot. SELinux should be used in ‘Targeted’ mode. Enforcement should be enabled. Any other suitable security arrangements may be used in alternative embodiments.

Only packages signed by KAL and Red Hat are accepted on the Linux side in this embodiment. All software updates on the host should be packages as RPM packages and signed. YUM should be configured to only accept RH and KAL signatures. Any other packages or unsigned packages should be blocked. It is noted that YUM and RPM are parts of the Red Hat package manager. Red Hat software is broken up into ‘packages’ and each package can be installed, updated or uninstalled. YUM and RPM are the commands for controlling installing/updating/uninstalling packages RPM packages should be installed via the Root Hypervisor Agent. There should be no other mechanism for installing packages. The KAL signing key should be installed such that it can be trusted by YUM.

For bootup, maximal security is achieved when the ATM is equipped with a UEFI system and a TPM. The TPM's PCR registers are used by both Linux and Windows to ensure the startup sequence is “measured” and verified to ensure no unauthorized changes have occurred in the UEFI firmware, nor the Linux system, nor the Windows system. PCRs are configuration registers that allow secure storage and reporting of security relevant metrics. These metrics can be used to detect changes to previous configurations and decide how to proceed. LUKS and Bitlocker retrieve their decryption keys using the TPM's “unseal” operation, and then decrypt and unlock the Linux partition and the Windows partition respectively.

The boot sequence should be secured against rootkit injection (both offline and online.)

For RHEL partitions, read/write and other access will be configured at the partition/mount level to minimize access.

For bootup on systems equipped with Legacy BIOS and TPM, good security is achieved when the ATM is equipped with a TPM on legacy BIOS systems. In this case, the boot sequence is similar to the UEFI+TPM scenario.

For bootup on systems without a TPM, the ATMs cannot be made cryptographically secure. However various techniques can be used to harden such ATMs. The BIOS boot sequence should be restricted to boot from the hard disk only and the BIOS configuration should be secured with a password. LUKS and Bitlocker may be used to encrypt the disk partitions and the keys are hidden as best as possible. TPM-less systems are vulnerable to offline attacks. Keys can be stored on the network, but without a TPM these keys continue to be vulnerable to offline attacks, as the ATM has no way of identifying itself in a cryptographically secure manner to the network. 3rd party products such as BlockGuard can help further harden the system.

After the system has booted, Linux may be secured using LUKS and SELinux and the Kalignite Linux Lockdown. Windows may be secured using Bitlocker, DeviceGuard, Applocker and the Kalignite Windows Lockdown. Both environments may be controlled by the Kalignite Hypervisor system.

For systems running the Kalignite suite on the Windows side, the Kalignite Hypervisor integrates with the Kalignite software suite so that the complete system is monitored and managed by KTC. Software distribution is achieved in the usual way with KTC packages that update the Windows side and the Linux side seamlessly. Only signed packages are accepted.

Both the Windows side and the Linux side are monitored by KTC. KTC is able to remotely reimage a complete environment including Linux and Windows without sending a technician onsite.

For systems running non-KAL software on the Windows side, Kalignite Hypervisor exposes an API so that the system can be managed using 3rd party management systems. Software distribution on the Windows side is then managed by the 3rd party system. Updates to the Kalignite Hypervisor must be delivered by the 3rd party system to an agreed location on the Windows side. Kalignite Hypervisor installs this package to update its components on the Windows side and Linux side, including updates to Linux itself. Only signed packages are accepted.

Optionally KTC may be used on 3rd party managed systems in parallel with the 3rd party system, in cooperation with each other.

In some embodiments there may be an additional (or more) Virtual Machine(s) (WM). The additional VM may host a different operating system from the first VM. For example, instead of Windows 10, the guest OS may be an update to Windows 10 or even an earlier operating system such as Windows 7. The host OS may be Linux for both VMs.

The first VM and the second VM (or plurality of VMs) may utilize services from each other, e.g. web services. For example, this may be XFS4IoT services, e.g. using WebSockets as transport.

Although much of the above description relates to Linux and Windows 10 acting as host Operating System (OS) and guest OS respectively, it will be appreciated that other operating systems could be used. For example, the guest OS may be Windows 2000 ®, Windows XP®, Windows 7 ® or updates to Windows 10 ®. In addition, it will be appreciated that the hypervisor or other virtual machine host is operable to provide a virtual machine (VM) and the hypervisor or other virtual machine host includes a host operating system, which may be a Linux operating system (i.e. Linux). Furthermore, it will be appreciated that the guest operating system (e.g. Windows 10) may be hosted within the virtual machine (VM).

Embodiments have been described in which the hypervisor or other virtual machine host provides a single virtual machine. In alternative embodiments the hypervisor or other virtual machine host provides a virtual machine and one or more further virtual machines on the user terminal and, optionally, two or more different guest operating systems on the different virtual machines. In such embodiments, the virtual machine and the further virtual machine(s) may be configured such that at least some software running on one of the virtual machine and the further virtual machine(s) is able to communicate with at least some software running on the other of the virtual machine and the further virtual machine(s). The virtual machine and the further virtual machine(s) in such embodiments may be configured such that service(s) running on one of the virtual machine and the further virtual machine(s) are accessible to the other of the virtual machine and the further virtual machine(s).

According to embodiments, aspects as outlined above may be implemented in any suitable apparatus for example any suitable automated teller machine (ATM) or other user terminal or apparatus. In some embodiments, for example, the user terminal may be one or more of one or more of a self-service terminal, an information kiosk, a terminal for providing goods or services to a user, a ticket purchase or dispensing terminal, a food or drink dispensing apparatus.

In some embodiments, one or more ATMs or other user terminals as described in WO 99/49431 or WO 2014/057237 may be modified to provide aspects as described above, for example so as to include one or more or each of hypervisor or other virtual machine host features, a virtual machine, a guest operating system that is hosted within the virtual machine, a plurality of devices and device drivers, and at least one application or other software configured to run on the virtual machine.

The contents of WO 99/49431 and WO 2014/057237 are hereby incorporated by reference.

It will be understood that the present invention has been described above purely by way of example, and modifications of detail can be made within the scope of the invention. Each feature disclosed in the description, and (where appropriate) the claims and drawings may be provided independently or in any appropriate combination.

1. A user terminal apparatus comprising:
a hypervisor or other virtual machine host, operable to provide a virtual machine;
a guest operating system that is hosted within the virtual machine;
a plurality of hardware devices;
a plurality of device drivers associated with the plurality of devices; and
at least one application or other software configured to run on the virtual machine to communicate with and/or control one or more of the devices via said guest operating system and via one or more of said device drivers, wherein
said one or more device drivers comprise device drivers that are supported by the hypervisor or other virtual machine host; and
at least some of said hardware devices that are supported by the hypervisor or other virtual machine host are unsupported by the guest operating system.

2. The apparatus according to claim 1, wherein at least one of:
the hypervisor or other virtual machine host includes a host operating system and the device drivers are supported by the host operating system, optionally a Linux operating system; or
the terminal apparatus comprises an automated teller machine (ATM).

3. (canceled)

4. The apparatus according to claim 1, wherein the at least one application or other software running on the virtual machine is at least one of:
operable to install software, on the hypervisor or other virtual machine host by receiving the software from a remote source and passing the software to the hypervisor or other virtual machine host;
configured to control operation of the user terminal apparatus; or
configured to control operation of a user interaction process that comprises a sequence of actions that comprises receiving user input via at least one of the hardware devices, and performing actions using one or more of the hardware devices in response to the user input, the process including sending messages between the at least one application or other software running on the virtual machine and the hardware devices supported by the hypervisor or other virtual machine host.

5. (canceled)

6. The apparatus according to claim 1, configured to send messages between the at least one application or other software running on the virtual machine and the hardware devices supported by the hypervisor or other virtual machine host.

7. (canceled)

8. The apparatus according to claim 1, wherein at least one of:
the apparatus is configured to have a normal operating mode of the apparatus in which the plurality of hardware devices are under control of the at least one application or other software running on the virtual machine despite at least some of the hardware devices being unsupported by, or having device drivers that are unsupported by, the guest operating system;
in the normal operating mode the at least one application or other software running on the virtual machine controls communication with a network, optionally including communication between the network and said hypervisor;
at least in the normal operating mode the apparatus appears to the network to be operating under the guest operating system; and/or wherein the at least one application or other software controls a network card of the apparatus; or
in the normal operating mode, the host operating system is a slave of the guest operating system.

9. (canceled)

10. (canceled)

11. (canceled)

12. The apparatus according to claim 1, wherein at least one of:
the virtual machine includes virtual device drivers and/or virtual devices under the guest operating system;
the virtual device drivers and/or virtual devices under the guest operating system are configured such that messages sent to the virtual device drivers and/or virtual devices are passed to one or more of the device drivers and/or hardware devices supported by the hypervisor or other virtual machine host; or
the messages are sent via middleware to the virtual device drivers, wherein the middleware optionally comprises at least one XFS service provider component.

13. (canceled)

14. (canceled)

15. The apparatus according to claim 1, wherein at least one of:
the apparatus is configured so that messages are sent using a tunneling process, between:—
the at least one application or other software running on the virtual machine; and
the hardware devices and/or the device drivers supported by the hypervisor or other virtual machine host and/or other software supported by the host operating system; or
the tunneling process comprises passing the messages through the hypervisor or other virtual machine host and/or through the host operating system, optionally a Linux operating system.

16. (canceled)

17. The apparatus according to claim 6, wherein at least one of:
the messages comprises control messages for controlling operation of one or more of the hardware devices;
the messages comprise data, optionally monitoring data, user input data or status data, from the hardware device drivers and/or the hardware devices; or
the monitoring data, user input data or status data is sent to the at least one application or other software configured to run on the virtual machine.

18. (canceled)

19. (canceled)

20. The apparatus according to claim 1, wherein the apparatus comprises at least one communication device that is configured to provide communication via a network and/or with at least one remote device.

21. The apparatus according to claim 20, wherein at least one of:
the at least one communication device comprises at least one of said hardware devices, optionally a network card;
the at least one application or other software configured to run on the virtual machine is configured to control operation of the at least one communication device thereby to control communication via the network;
the application or other software configured to run on the virtual machine is configured to communicate with the communication device; or
the at least one application or other software configured to run on the virtual machine is configured to establish a communication channel via the communication device with a remote management resource.

22. (canceled)

23. (canceled)

24. (canceled)

25. The apparatus according to claim 1, further comprising at least one bridge between the virtual machine and the hypervisor or other virtual machine host.

26. The apparatus according to claim 25, wherein at least one of:
the at least one bridge is between the guest operating system and the host operating system;
the at least one bridge is configured to provide for messages to be sent between the virtual machine and the hypervisor or other virtual machine host; or
the messages sent via the at least one bridge comprise at least one of monitoring data, instructions, control messages for controlling operation of at least one aspect of at least one of the hypervisor, host operating system or software or hardware operating under the host operating system, or software updates.

27. (canceled)

28. (canceled)

29. The apparatus according to claim 1, wherein the at least one application or other software configured to run on the virtual machine comprises at least one monitoring component for monitoring operation of at least part of the user terminal apparatus.

30. The apparatus according to claim 29, wherein at least one of:
the at least one monitoring component monitors both at least some operations under the guest operating system, and at least some operations of the hypervisor or other virtual machine host;
the at least one monitoring component monitors operation of at least one of the hardware devices and/or hardware device drivers;
the at least one monitoring component is configured to operate under control of the remote management resource;
the remote management resource is responsive to monitoring data sent via the monitoring component to send messages to the virtual machine and/or to the hypervisor or other virtual machine host; or
the at least one application or other software running on the virtual machine is configured to pass messages from the remote management resource intended for the hypervisor or other virtual machine host via the at least one bridge.

31. (canceled)

32. (canceled)

33. (canceled)

34. (canceled)

35. The apparatus according to claim 1, wherein at least one of:
the at least one application or other software running on the virtual machine is configured to pass messages intended for the hypervisor or other virtual machine host using the at least one bridge; or
the message intended for the hypervisor or other virtual machine host comprise at least one of: one or more control command, a software update, an executable, a script, debugging or testing software.

36. (canceled)

37. (canceled)

38. (canceled)

39. The apparatus according to claim 1, wherein at least one of:
the virtual machine host and/or guest operating system is locked, and the hypervisor or other virtual machine host, optionally the host operating scheme, is locked; or
the virtual machine host and/or guest operating system is locked using a first encryption scheme, and the hypervisor or other virtual machine host, optionally the host operating scheme, is locked using a second, different encryption scheme.

40. (canceled)

41. (canceled)

42. The apparatus according to claim 1, wherein at least one of:
the hypervisor or other virtual machine host comprises a Linux® hypervisor;
the hypervisor or other virtual machine host comprises Quick EMULator (QEMU);
the hypervisor or other virtual machine host comprises Kernel-based Virtual Machine (KVM) software; or
the guest operating system comprises a Windows® operating system.

43. (canceled)

44. (canceled)

45. (canceled)

46. The apparatus according to claim 1, wherein at least one of:
the hypervisor is configured to provide at least one further virtual machine;
the virtual machine and the further virtual machine are configured such that at least some software running on one of the virtual machine and the further virtual machines is able to communicate with at least some software running on the other of the virtual machine and the further virtual machines;
the virtual machine and the further virtual machines are configured such that service running on one of the virtual machine and the further virtual machine is accessible to the other of the virtual machine and the further virtual machine; or
the services comprise XFS4IoT services and/or wherein WebSockets are used to communicate between the virtual machine host and the further virtual machine host.

47. (canceled)

48. (canceled)

49. (canceled)

50. A method of operating a user terminal apparatus that comprises a plurality of hardware devices, the method comprising:
providing a virtual machine;
hosting a guest operating system by the virtual machine;
providing at least one application or other software configured to run on the virtual machine to communicate with and/or control one or more of the devices via said guest operating system and via one or more device drivers, wherein
said one or more device drivers comprise device drivers that are supported by the hypervisor or other virtual machine host; and
at least some of said hardware devices supported by the hypervisor or other virtual machine host are unsupported by the guest operating system.

51. (canceled)

52. The computer program product comprising computer readable instructions that are operable to perform a method according to claim 50.
